(19) United States
(12) Patent Application Publication
(10) Pub. No.: US 2024/0261827 A1
(43) Pub. Date: Aug. 8, 2024

(54) AUTOMATED ULTRASONIC BATH FILL AND DRAIN SYSTEM

(71) Applicant: SKYWORKS SOLUTIONS, INC., Irvine, CA (US)

(72) Inventors: Enrico Marcelo Sy, Mexicali (MX); Zelman Hernandez Castro, Imperial, CA (US)

(21) Appl. No.: 18/422,705

(22) Filed: Jan. 25, 2024

Related U.S. Application Data
(60) Provisional application No. 63/443,205, filed on Feb. 3, 2023.

(51) Int. Cl. B08B 3/12

(52) U.S. Cl. CPC B08B 3/12

(57) ABSTRACT

Disclosed herein is a system comprising an ultrasonic bath, a first level sensor configured to provide a signal representative of an amount of liquid in the ultrasonic bath, and a controller configured to receive the signal from the first level sensor and automatically drain and empty the ultrasonic bath based on the signal as well as methods of operating same.

### CROSS-REFERENCE TO RELATED APPLICATIONS

This application claims priority under 35 U.S.C. § 119(e) to U.S. Provisional Patent Application Ser. No. 63/443,205, titled “AUTOMATED ULTRASONIC BATH FILL AND DRAIN SYSTEM,” filed Feb. 3, 2023, the entire content of which is incorporated herein by reference for all purposes.

### BACKGROUND

### 1. Field of Invention

Aspects and embodiments disclosed herein are generally directed to ultrasonic baths for the cleaning of assembled electronic components or modules.

### 2. Discussion of Related Art

During assembly of an electronic module having a substrate of, for example, a printed circuit board, solder may be used to attach various discreet or packaged electronic devices to the printed circuit board. Solder may leave behind traces of flux and the assembled module may also have other surface contaminants that should be removed. One method of cleaning assembled electronic modules is by submerging them in an ultrasonic bath filled with a cleaning solution and applying ultrasonic energy to facilitate dissolution and/or removal of contaminants from the assembled electronic module.

### SUMMARY

In accordance with one aspect, there is provided a system comprising an ultrasonic bath, a first level sensor configured to provide a signal representative of an amount of liquid in the ultrasonic bath, and a controller configured to receive the signal from the first level sensor and automatically drain and empty the ultrasonic bath based on the signal.

In some embodiments, the first level sensor is a load cell.

In some embodiments, the system further comprises a source of water and a source of cleaning chemical, and the controller is further configured to cause the source of water and the source of cleaning chemical to fill the ultrasonic bath with a predetermined ratio of the water to the cleaning chemical based on the signal from the first level sensor.

In some embodiments, the controller is configured to fill the ultrasonic bath with one of the water or the cleaning chemical to a first level based on the signal from the first level sensor and then to further fill the ultrasonic bath with the other of the water or the cleaning chemical to a second level based on the signal from the first level sensor.

In some embodiments, the system further comprises a second level sensor configured to provide a signal representative of an amount of the cleaning chemical in the source of cleaning chemical.

In some embodiments, the second level sensor is a load cell.

In some embodiments, the controller is further configured, responsive to receiving an instruction to fill the ultrasonic bath, to check if sufficient cleaning chemical is present in the source of cleaning chemical based on the signal from the second level sensor prior to initiating filling of the ultrasonic bath. In some embodiments, the controller is further configured to initiate filing of the ultrasonic bath responsive to receiving the instruction to fill the ultrasonic bath only if sufficient cleaning chemical is present in the source of cleaning chemical to supply a predetermined amount of the cleaning chemical to the ultrasonic bath.

In some embodiments, the system further comprises a residue tank configured to receive spent cleaning solution drained from the ultrasonic bath, and a third level sensor configured to provide a signal representative of spent cleaning solution in the residue tank.

In some embodiments, the third level sensor is a load cell.

In some embodiments, the controller is further configured, responsive to receiving an instruction to drain the ultrasonic bath, to check if sufficient volume remains in the residue tank to receive the spent cleaning solution from the ultrasonic bath based on the signal from the third level sensor prior to initiating draining of the ultrasonic bath.

In some embodiments, the controller is further configured to initiate draining of the ultrasonic bath responsive to receiving the instruction to drain the ultrasonic bath only if sufficient volume remains in the residue tank to receive the spent cleaning solution from the ultrasonic bath.

In some embodiments, the system further comprises a user interface including controls to provide for a user to instruct the controller to fill the ultrasonic bath, to drain the ultrasonic bath, and to drain the ultrasonic bath and automatically refill the ultrasonic bath.

In accordance with another aspect, there is provided a method of filling and draining an ultrasonic bath. The method comprises checking, by a controller, responsive to receiving an instruction from a user interface to fill the ultrasonic bath, a first signal from a first level sensor associated with the ultrasonic bath to determine if the ultrasonic bath is empty, and a second signal from a second level sensor associated with a source of cleaning chemical to determine if sufficient cleaning chemical is available to dispense a predetermined amount of cleaning chemical into the ultrasonic bath, initiating, by the controller, an ultrasonic bath fill operation responsive to the first signal being indicative of the ultrasonic bath being empty and the second signal being indicative of the availability of sufficient cleaning chemical, not initiating, by the controller, the ultrasonic bath fill operation responsive to the first signal being indicative of the ultrasonic bath not being empty or the second signal being indicative of the availability of insufficient cleaning chemical, checking, by the controller, responsive to receiving an instruction to drain spent cleaning solution from the ultrasonic bath at the controller from the user interface, a third signal from a third level sensor associated with a residue tank to determine if the residue tank has sufficient remaining empty volume to receive all of the spent cleaning solution from the ultrasonic bath, initiating, by the controller, an ultrasonic bath drain operation responsive to the third signal being indicative of the residue tank having sufficient remaining empty volume to receive all of the spent cleaning solution from the ultrasonic bath, and not initiating, by the controller, the ultrasonic bath drain operation responsive to the third signal being indicative of the residue tank not having sufficient remaining empty volume to receive all of the spent cleaning solution from the ultrasonic bath.

In some embodiments, initiating the ultrasonic bath fill operation includes adding water to the ultrasonic bath until the first signal is indicative of a predetermined amount of water having been added to the ultrasonic bath and then adding cleaning chemical to the ultrasonic bath until the first signal is indicative of a predetermined amount of cleaning chemical having been added to the ultrasonic bath.

In some embodiments, the method comprises adding the water to the ultrasonic bath while a supply of the cleaning chemical to the ultrasonic bath is stopped.

In some embodiments, the method comprises adding the cleaning chemical to the ultrasonic bath while a supply of the water to the ultrasonic bath is stopped.

In some embodiments, checking the first signal from the first level sensor associated with the ultrasonic bath includes performing a measurement of weight of the ultrasonic bath.

In some embodiments, checking the second signal from the second level sensor associated with the source of cleaning chemical includes performing a measurement of weight of the source of cleaning chemical.

In some embodiments, checking the third signal from the third level sensor associated with the residue tank includes performing a measurement of weight of the residue tank.

### BRIEF DESCRIPTION OF DRAWINGS

Various aspects of at least one embodiment are discussed below with reference to the accompanying drawings. In the drawings, which are not intended to be drawn to scale, each identical or nearly identical component that is illustrated in various drawings is represented by a like numeral. For purposes of clarity, not every component may be labeled in every drawing. The drawings are provided for the purposes of illustration and explanation, and are not intended as a definition of the limits of the invention. In the drawings:

FIG. 1 schematically illustrates a system as disclosed herein;

FIG. 2 schematically illustrates components and connections between same in a system as disclosed herein;

FIG. 3 illustrates an embodiment of a user interface for system as disclosed herein;

FIG. 4 is a flowchart of an embodiment of an automated ultrasonic bath fill process;

FIG. 5 is a flowchart of an embodiment of an automated ultrasonic bath drain process; and

FIG. 6 is a flowchart of an embodiment of an automated ultrasonic bath fill or drain process.

### DETAILED DESCRIPTION

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements, and features discussed in connection with any one or more embodiments are not intended to be excluded from a similar role in any other embodiments. Any references to front and back, left and right, top and bottom, and upper and lower are intended for convenience of description, not to limit the present systems and methods or their components to any one positional or spatial orientation. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

In some electronic module assembly operations, ultrasonic baths used to clean assembled electronic modules may be manually filled with water and cleaning chemicals to form a cleaning solution. The manual nature of such operations has a number of disadvantages. The manual handling of chemicals is typically considered unsafe due to the possibility of spilling the chemicals and exposing an operator to the chemicals or leaving a spill on the floor which may cause a slip hazard. Further, if a particular ratio of water to cleaning chemical is desired in an ultrasonic bath, it may be difficult to accurately and consistently achieve this desired ratio through manual filling of the bath.

Aspects and embodiments of the present disclosure are generally directed to systems and methods of automated filling and draining of ultrasonic baths, which may eliminate some of the disadvantages of manual filling of ultrasonic baths.

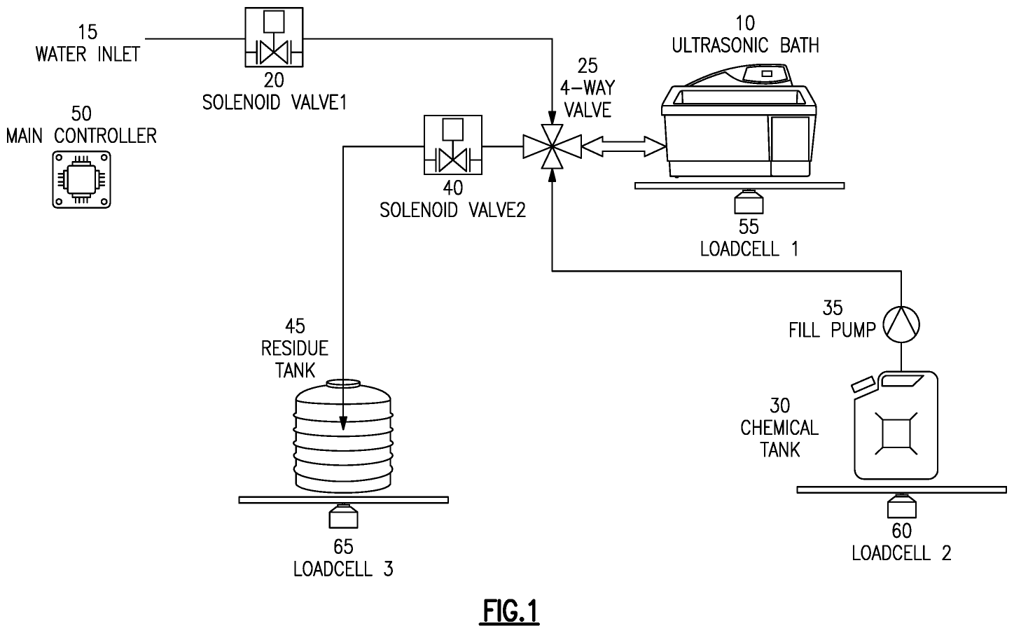

One embodiment of a system for automated filling and draining of an ultrasonic bath is illustrated schematically in FIG. 1. The system includes an ultrasonic bath 10 that receives water, for example, deionized water, from a water inlet 15 through a valve 20, for example, a solenoid valve (“Solenoid Valve 1” in FIG. 1) and a four-way valve 25. The ultrasonic bath also receives cleaning chemicals, for example, one of the Aquanox™ series of cleaning chemicals available from Kyzen Corporation from a source of chemical 30 (“Chemical Tank” in FIG. 1) through a fill pump 35 and through the four-way valve 25. The water and cleaning chemicals are provided in a predetermined ratio to form a cleaning solution of desired concentration in the ultrasonic bath.

After the water/chemical cleaning solution in the ultrasonic bath has been used for a sufficient time that fresh cleaning solution is desired, the spent cleaning solution is drained from the ultrasonic bath through another valve 40, for example, another solenoid valve (“Solenoid Valve 2” in FIG. 1) and into a residue tank 45. The various valves and pumps are controlled by a main controller 50 which may be a general purpose computer, DSP, ASIC, or other form of electronic or computerized controller known in the art.

Each of the ultrasonic bath, source of chemical, and residue tank include liquid level sensors in communication with the main controller. FIG. 1 illustrates these liquid level sensors as load cells 55, 60, 65 which can be used to determine how much liquid is present in each of the ultrasonic bath, source of chemical, and residue tank based on their respective weights. In other embodiments other level sensors, for example, ultrasonic sensors, float sensors, or other forms of level sensors known in the art could be utilized, although the level sensor should either not contact the cleaning solution or be non-reactive with the cleaning solution.

As the ultrasonic bath is being filled the controller may utilize the level sensor associated with the ultrasonic bath to monitor the amount of liquid added to the ultrasonic bath and stop filling when the bath is filled to a desired level and before the bath becomes overfull and cleaning solution is spilled. In some embodiments, the controller first fills the ultrasonic bath with a desired amount of one of the chemical or the water as measured by the level sensor of the ultrasonic bath and then adds a desired amount of the other of the chemical or the water as measured by the change in liquid level sensed by the level sensor of the ultrasonic bath. When a load cell is used as the level sensor the controller may be calibrated to account for the different densities of water and chemical to determine what change in weight, as measured by the load cell, corresponds to a given amount of added cleaning chemical or water. In other embodiments, flow rate sensors may be present as part of the chemical fill pump and/or water solenoid valve, or as separate components on the water and cleaning chemical fill lines, to provide feedback to the main controller which will adjust the water solenoid valve and/or chemical fill pump to add water and chemical at a desired rate and/or time achieve a desired ratio of water to chemical in the ultrasonic bath.

The liquid level sensor associated with the cleaning chemical tank provides an indication of cleaning chemical remaining in the cleaning chemical tank to the main controller. The main controller may provide a warning that the cleaning chemical tank should be refilled or replaced if the cleaning chemical remaining in the cleaning chemical tank drops to below a predetermined amount. The main controller may also deny a request to fill the ultrasonic bath if insufficient cleaning chemical remains in the chemical tank.

The liquid level sensor associated with the residue tank provides an indication of the amount of spent cleaning solution in the residue tank to the main controller. If the amount of spent cleaning solution in the residue tank is above a predetermined level, the main controller may issue a warning that the residue tank should be drained or replaced. The main controller may deny a request to drain the ultrasonic tank if the residue tank is too full to accommodate the drained spent cleaning solution.

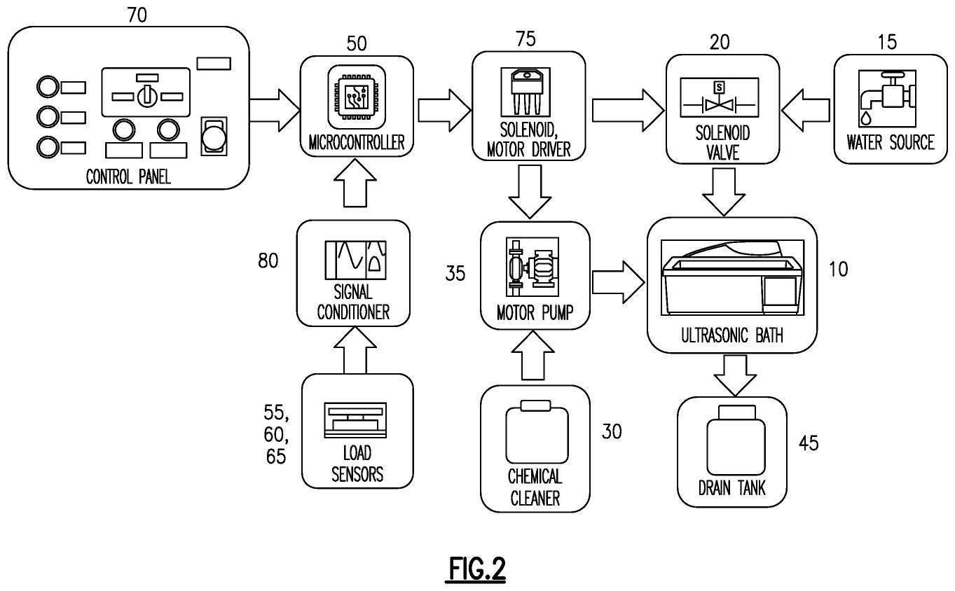

A more detailed block diagram of an embodiment of a system for automated filling and draining of an ultrasonic bath is illustrated schematically in FIG. 2. The main controller 50, illustrated in FIG. 2 as a microcontroller, may present a user interface 70 to an operator through which the operator may enter commands, for example, to fill or empty the ultrasonic bath 10 and what level the ultrasonic bath should be filled to. The microcontroller 50 interfaces with and controls operation of the cleaning chemical pump 35 (the “Motor Pump” in FIG. 2) through a solenoid/motor driver 75, and controls operation of the solenoid valves (only valve 20 shown in FIG. 2) on the water inlet line and the drain line to the residue tank 45 (the “Drain Tank” in FIG. 2). The level sensors 55, 60, 65, e.g., load sensors that measure the liquid levels in each of the ultrasonic bath, cleaning chemical tank 30 (“Chemical Cleaner” in FIG. 2), and residue tank communicate with the main controller through signal conditioners 80 to provide the main controller with information regarding the liquid levels in the ultrasonic bath, cleaning chemical tank, and residue or drain tank.

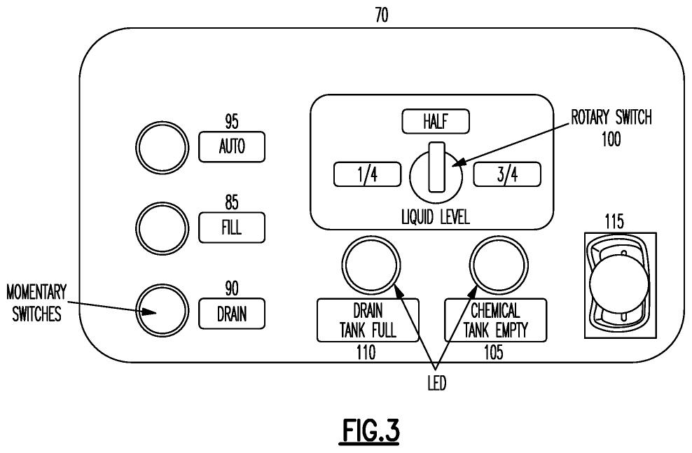

An enlarged view of the user interface 70 is shown in FIG. 3. In some embodiments, as illustrated in FIG. 3, the user interface may include three buttons 85, 90, 95 to control filling and draining of the ultrasonic bath, a first 85 to cause the ultrasonic bath to fill, a second 90 to cause the ultrasonic bath to drain, and a third 95 to cause the ultrasonic bath to drain and then refill, or to drain if full and fill if empty. A selector 100, e.g., a rotary switch, may be provided for a user to select a fill level for the ultrasonic bath, for example, one quarter full, one half, full, or three quarters full. Warning indicators may be present to provide an indication of a low liquid level in the cleaning chemical supply tank (warning light 105) or a high liquid level in the residue tank (warning light 110). An emergency cut-off switch 115 may be provided to allow an operator to cut power to the system in an emergency.

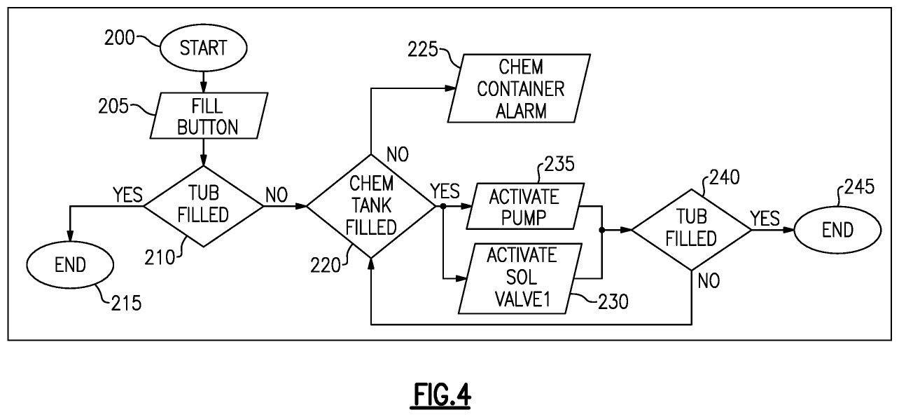

A flow chart of a process for filling the ultrasonic bath is shown in FIG. 4. The method starts at act 200 and an operator presses the fill button on the system user interface (act 205). The main controller checks a measurement signal from the level sensor for the ultrasonic bath to determine if the ultrasonic bath is already full or not (decision act 210). If the controller determines from the measurement signal from the level sensor for the ultrasonic bath that the ultrasonic bath is already full the method ends (act 215) and no further action is taken. If the controller determines from the measurement signal from the level sensor for the ultrasonic bath that the ultrasonic bath is not full or is empty, the controller checks a measurement signal from the level sensor for the cleaning chemical supply tank to determine if sufficient cleaning chemical remains to fill the ultrasonic bath to the desired level (decision act 220). If the controller determines from the measurement signal from the level sensor for the cleaning chemical supply tank that insufficient cleaning chemical is present to fill the ultrasonic bath to the desired level the fill operation is aborted by the controller and the controller causes an alarm to be presented on the system user interface and/or to facilities personnel responsible for the cleaning chemical supply tank that indicates that the cleaning chemical supply tank should be refilled or replaced with a new cleaning chemical supply tank (act 225). If the controller determines from the measurement signal from the level sensor for the cleaning chemical supply tank that enough cleaning chemical is present to fill the ultrasonic bath to the desired level the controller initiates an ultrasonic bath fill operation by activating the water flow control valve (act 230) and the cleaning chemical pump (act 235). In some embodiments, the water flow control valve is first opened while the cleaning chemical pump remains off until the ultrasonic bath level sensor provides a signal that indicates that a desired amount of water has been added to the ultrasonic bath. The water flow control valve is then closed and the cleaning chemical pump turned on until the ultrasonic bath level sensor provides a signal that indicates that a desired amount of cleaning chemical has been added to the ultrasonic bath to mix with the water and form the cleaning solution. In other embodiments the order of addition of water and cleaning chemical may reversed, or the water and cleaning chemical may be added at the same time, for example, if flow monitors are included in the system to monitor the amount of cleaning chemical and water added so the controller can turn off the flow of water and cleaning chemical when the desired amount of each, as measured by the flow monitors, has been added to the ultrasonic bath. When the ultrasonic bath is filled with the desired amount of water and cleaning chemical the process for filling the ultrasonic bath ends (act 250).

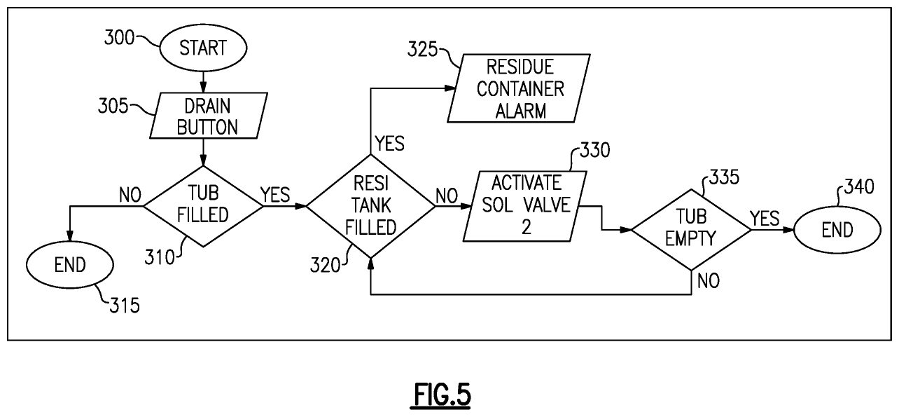

A flow chart of a process for draining the ultrasonic bath is shown in FIG. 5. The method starts at act 300 and an operator presses the drain button on the system user interface (act 305). The main controller checks a measurement signal from the level sensor for the ultrasonic bath to determine if the ultrasonic bath is already full or not (decision act 310). If the ultrasonic bath is already empty the controller terminates the drain process (act 315). If the ultrasonic bath is not empty, the controller checks a measurement signal from the level sensor for the residue tank to determine if there is sufficient remaining capacity in the residue tank to drain the ultrasonic bath into (decision act 320). If the residue tank is full or does not have enough remaining capacity to receive the volume of spent cleaning solution from the ultrasonic bath, the controller terminates the drain process and the controller causes an alarm to be presented on the system user interface and/or to facilities personnel responsible for the residue tank that indicates that the residue tank should be drained or replaced with a new residue tank (act 325). If the controller determines from the measurement signal from the level sensor for the residue tank that enough residue tank capacity remains to drain the ultrasonic bath into the residue tank the controller initiates an ultrasonic bath drain operation by activating the drain control valve (act 330). The process continues until a measurement signal from the ultrasonic bath level sensor indicates to the controller that the ultrasonic bath is empty (decision act 335). During the drain process the signal from the level sensor for the residue tank is constantly (or periodically) monitored by the controller which may terminate the drain operation if the controller determines that the residue tank has become full and is in danger of overflowing. The process ends when the ultrasonic bath is empty (act 340).

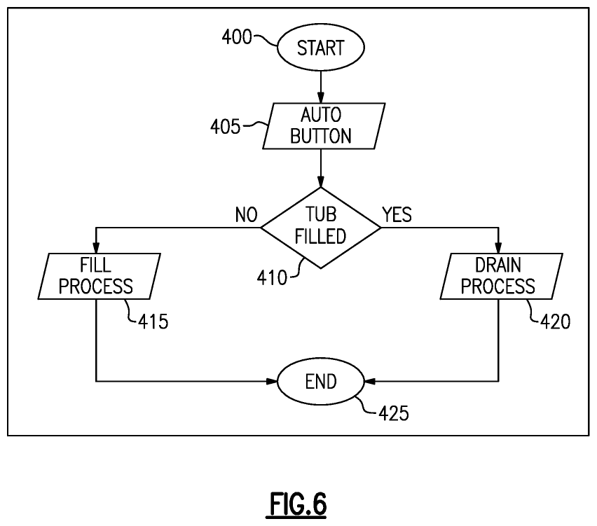

In accordance with another method, an operator may instruct the controller to automatically fill the ultrasonic tank if it is empty or drain the ultrasonic tank if it is full. A flowchart of this process is shown in FIG. 6. The method begins at act 400 and the operator presses the “Auto Fill” button on the user interface (act 405). The controller checks a signal from the level sensor for the ultrasonic bath (decision act 410). If the ultrasonic bath level sensor indicates the bath is empty, a fill process such as illustrated in the flow chart of FIG. 4 is automatically initiated without requiring the operator to press the fill button on the user interface (act 415). If the ultrasonic bath level sensor indicates the bath is full, a drain process such as illustrated in the flow chart of FIG. 5 is automatically initiated without requiring the operator to press the drain button on the user interface (act 420). The process ends when the ultrasonic bath has been emptied or filled (act 425). In further embodiments, pressing the “Auto” button when the ultrasonic bath is full may cause the controller to automatically fill the ultrasonic bath again subsequent to draining the ultrasonic bath.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure.

What is claimed is:

1. A system comprising:
an ultrasonic bath;
a first level sensor configured to provide a signal representative of an amount of liquid in the ultrasonic bath; and
a controller configured to receive the signal from the first level sensor and automatically drain and empty the ultrasonic bath based on the signal.

2. The system of claim 1 wherein the first level sensor is a load cell.

3. The system of claim 1 further comprising a source of water and a source of cleaning chemical, wherein the controller is further configured to cause the source of water and the source of cleaning chemical to fill the ultrasonic bath with a predetermined ratio of the water to the cleaning chemical based on the signal from the first level sensor.

4. The system of claim 3 wherein the controller is configured to fill the ultrasonic bath with one of the water or the cleaning chemical to a first level based on the signal from the first level sensor and then to further fill the ultrasonic bath with the other of the water or the cleaning chemical to a second level based on the signal from the first level sensor.

5. The system of claim 3 further comprising a second level sensor configured to provide a signal representative of an amount of the cleaning chemical in the source of cleaning chemical.

6. The system of claim 5 wherein the second level sensor is a load cell.

7. The system of claim 5 wherein the controller is further configured, responsive to receiving an instruction to fill the ultrasonic bath, to check if sufficient cleaning chemical is present in the source of cleaning chemical based on the signal from the second level sensor prior to initiating filling of the ultrasonic bath.

8. The system of claim 7 wherein the controller is further configured to initiate filing of the ultrasonic bath responsive to receiving the instruction to fill the ultrasonic bath only if sufficient cleaning chemical is present in the source of cleaning chemical to supply a predetermined amount of the cleaning chemical to the ultrasonic bath.

9. The system of claim 1 further comprising a residue tank configured to receive spent cleaning solution drained from the ultrasonic bath, and a third level sensor configured to provide a signal representative of spent cleaning solution in the residue tank.

10. The system of claim 9 wherein the third level sensor is a load cell.

11. The system of claim 9 wherein the controller is further configured, responsive to receiving an instruction to drain the ultrasonic bath, to check if sufficient volume remains in the residue tank to receive the spent cleaning solution from the ultrasonic bath based on the signal from the third level sensor prior to initiating draining of the ultrasonic bath.

12. The system of claim 11 wherein the controller is further configured to initiate draining of the ultrasonic bath responsive to receiving the instruction to drain the ultrasonic bath only if sufficient volume remains in the residue tank to receive the spent cleaning solution from the ultrasonic bath.

13. The system of claim 1 further comprising a user interface including controls to provide for a user to instruct the controller to fill the ultrasonic bath, to drain the ultrasonic bath, and to drain the ultrasonic bath and automatically refill the ultrasonic bath.

14. A method of filling and draining an ultrasonic bath, the method comprising:
checking, by a controller, responsive to receiving an instruction from a user interface to fill the ultrasonic bath, a first signal from a first level sensor associated with the ultrasonic bath to determine if the ultrasonic bath is empty, and a second signal from a second level sensor associated with a source of cleaning chemical to determine if sufficient cleaning chemical is available to dispense a predetermined amount of cleaning chemical into the ultrasonic bath;
initiating, by the controller, an ultrasonic bath fill operation responsive to the first signal being indicative of the ultrasonic bath being empty and the second signal being indicative of the availability of sufficient cleaning chemical;
not initiating, by the controller, the ultrasonic bath fill operation responsive to the first signal being indicative of the ultrasonic bath not being empty or the second signal being indicative of the availability of insufficient cleaning chemical;
checking, by the controller, responsive to receiving an instruction to drain spent cleaning solution from the ultrasonic bath at the controller from the user interface, a third signal from a third level sensor associated with a residue tank to determine if the residue tank has sufficient remaining empty volume to receive all of the spent cleaning solution from the ultrasonic bath;
initiating, by the controller, an ultrasonic bath drain operation responsive to the third signal being indicative of the residue tank having sufficient remaining empty volume to receive all of the spent cleaning solution from the ultrasonic bath; and
not initiating, by the controller, the ultrasonic bath drain operation responsive to the third signal being indicative of the residue tank not having sufficient remaining empty volume to receive all of the spent cleaning solution from the ultrasonic bath.

15. The method of claim 14 wherein initiating the ultrasonic bath fill operation includes adding water to the ultrasonic bath until the first signal is indicative of a predetermined amount of water having been added to the ultrasonic bath and then adding cleaning chemical to the ultrasonic bath until the first signal is indicative of a predetermined amount of cleaning chemical having been added to the ultrasonic bath.

16. The method of claim 15 comprising adding the water to the ultrasonic bath while a supply of the cleaning chemical to the ultrasonic bath is stopped.

17. The method of claim 15 comprising adding the cleaning chemical to the ultrasonic bath while a supply of the water to the ultrasonic bath is stopped.

18. The method of claim 14 wherein checking the first signal from the first level sensor associated with the ultrasonic bath includes performing a measurement of weight of the ultrasonic bath.

19. The method of claim 14 wherein checking the second signal from the second level sensor associated with the source of cleaning chemical includes performing a measurement of weight of the source of cleaning chemical.

20. The method of claim 14 wherein checking the third signal from the third level sensor associated with the residue tank includes performing a measurement of weight of the residue tank.
